(19) United States
(12) Patent Application Publication
(10) Pub. No.: US 2007/0233605 A1
(43) Pub. Date: Oct. 4, 2007

(54) Method and System to Provide Certified Third Party Plug-ins into a Patent Drafting System

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,475

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. H04L 9/00

(52) U.S. Cl. 705/52

(57) ABSTRACT

A system wherein software developers can develop modules compatible for use with a patent application drafting tool (PDT) is described. The PDT and modules may or may not be part of a open source system. Various fee systems are also described wherein the owner or provider of the PDT and software developers may or may not share revenue. A peer (or other) review system may be implemented to identify modules that are performing well and those that are performing poorly.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

In various embodiments, the present disclosure provides a system or framework that allows third parties to develop improvement plug-ins or software modules for a patent drafting/search/examination engine. The source code and/or application program interfaces (API's) for the system and/or framework may be made available, in whole or in part, to third party developers, who can create improvements to any one or more of the existing framework, applications or modules and/or create new or improved software, plug-ins or modules (collectively “modules”) and submit them to the central system for review/approval. The improvements may be tested by a central or other authorized body and/or by other end users, and implemented if the modules or improvements prove themselves as both useful and error free.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. An exemplary system and method for sending alerts is described in U.S. patent application Ser. No. 11/676,848, which is hereby incorporated by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application, —includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes.

Patent Application—includes an invention disclosure that has been filed with a registration entity such as the USPTO

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, in various embodiments the present disclosure provides a system or framework that allows third parties to develop improvement plug-ins or software modules for a patent drafting/search/examination engine. The design and creation of the modules and/or APIs may be accomplished by any suitable means. Numerous methods to devise such modules and/or API's are well known and documented within the prior art. For example, methods to provide for and designs of various application program interfaces or APIs and other inter-application communications are provided and discussed in the following books entitled: “A Highly Adaptable Generic Event-Based Message Channel Design for Loosely Coupling Software Modules” by Cihat Eryigit, “Professional Development with Web APIs, by Denise M. Gosnell “Professional Web APIs with PHP,” by Paul Reinheimer, “IEEE Standard for Information Technology, Osi Application Program Interfaces-File Transfer, Access, and Management (C Language) (Ieee Std 1238.1-1994), by IEEE Computer Society. Portable Applications Standards Committee, “1224.2-1993: IEEE Standard for Information Technology-Directory Services Application Program Interface, Api-Language Independent Specification, ANSI (IEEE Standard for Information Technology), by IEEE (Author), Institute of Electrical & Electronics, and “C#: Your Visual Blueprint for Building .Net Applications (With CD-ROM) (Paperback), by Eric Butow, Thomas Ryan, MaranGraphics, which are hereby incorporated by reference.

Generally, a patent application drafting, submission, and examination tool (PDT) as contemplated by the present disclosure is a web-based software module that enables an end user to submit a patent application with a registration entity such as the United States Patent and Trademark Office (USPTO). The PDT may further aid in the initially preparation of the application, for example, by using automated or semi-automated suggestions and/or prior art searching. The PDT may additionally aid with fully or partially automated examination of the application once it has been submitted. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference.

According to an embodiment, the modules developed using the systems and methods can be utilized to improve a patent application drafting, submission, and examination tool.

According to various embodiments, end users may or may not have to pay one or more fees to access and/or use the PDT and/or added modules. For example, the owner of the PDT (which may be for example, the USPTO, a private third party, or some other entity) may determine a fixed or variable fee to use the patent drafting tool. Furthermore, developers that submit modules to be used with the PDT may require an additional fee for using such additional modules. There may be a combination of fee types, for example, the USPTO might charge a flat rate for the creation and submission of a patent application using the PDT, while some modules may charge a per use fee, some modules charge an hourly rate, and some modules are free. Alternatively, use of the PDT may be free, while some or all of the modules may be fee-based. Furthermore, the owner(s), operator(s), or host(s) of the system or servers on which the PDT and/or one or more modules reside, may also charge a fee, instead of or in addition to any other fee.

Fees, whether for the servers, system, framework, or modules, may be established by any applicable means, including, but not limited to: negotiations among the affected or controlling parties, free market forces, bidding or auctions, or by a regulatory body or entity, e.g., by one or more USPTO rules or regulations, and/or by US and/or other laws or regulations passed by any duly authorized governing body, e.g., a foreign country, or agency, or group of end users or other committee established for such purposes, or by a court of competent jurisdiction, and/or via a vote or other democratic processes and/or any combination of the forgoing.

Fees may be shared between any one or more entities. For example, developers that submit modules and charge a fee for use of their module may optionally or may be required to share a percentage of a fixed or variable amount of the fees they collect with the USPTO or other developers and/or other third parties, services providers or any other entity, as deemed appropriate.

According to some embodiments, developers that submit modules that are subsequently approved and/or otherwise used, may be permitted to use the system, framework and/or other developer's modules, in whole or in part, for free or for a reduced free structure. For example, if Developer A submits a spell checking tool and Developer B submits a lexicon creation tool, either Developer A and/or Developer B may be granted certain benefits, which may be temporary or permanent, including, for example, reduced fees for using the entire system and/or reduce fees for using each other's modules. Such fee structures and arrangements may be determined by any applicable means, including negotiations among the affected or interested parties, the USPTO, or any other duly authorized governing party, and/or by free market forces, etc.

In certain embodiments, all modules and software including the PDT may be entirely or partially open source code. In such instances, the developers of new or improved modules may not be permitted to apply for patent protection. Alternatively, developers may be permitted to apply for patent protection, but the owners or assignees of patents stemming from work associated with the PDT may or may not be permitted to charge a royalty when or if such inventions are practiced within the PDT.

According to some embodiments, the PDT can serve as a marketplace for modules to be discussed, developed, reviewed, approved and/or inserted or used by end users that are drafting and/or reviewing and/or examining patent applications.

In some embodiments, the modules, or software, may act or be implemented as plug-ins that can be installed into or linked with or to the system and/or framework and used for patent drafting.

In certain embodiments, only approved plug-ins can be used to create certified patent applications. Such approval may be conducted by any applicable means including, but not limited to: a peer review process, a formal certification process conducted by authorized professionals, a virtual review process, i.e., tested by players or player characters within a video game environment, alpha and/or beta testing, e.g., testing of the application within a limited scope and/or with only a limited number of end users or for a limited period and/or any combination or order of the forgoing. For example, to obtain approval a given module might first be required to pass a peer review or other inspection and, if it passes such inspection, may then be required to undergo a formal review. Alternatively, after passing a peer review, a module may be approved to move directly into alpha or beta testing and/or may be then inserted directly or otherwise linked into the PDT framework or made available for immediate use by end users.

Methods to provide for quality assurance while developing software and/or manual or automated software testing are well known in the prior art. Several of the myriad methods to ensure quality control and/or testing are discussed and disclosed in the following books entitled: “Software Quality Assurance: Principles And Practice, by Nina S. Godbole, “Software Testing and Continuous Quality Improvement, Second Edition, by William E. Lewis, “Software Testing (2nd Edition), by Ron Patton, “Testing IT: An Off-the-Shelf Software Testing Process (Paperback) by John Watkins” and “Effective Software Test Automation: Developing an Automated Software Testing Tool, by Kanglin Li, Mengqi Wu and Sybex, which are incorporated by reference.

Numerous commercial applications exist that can be used to complete the automated testing and/or other review processes, including, for example, the following: TestComplete5 by Automated QA of Las Vegas, Nev., and/or TestMaker by Pushtotest.com, and/or any one or more of the testing tools cited at: http://www.softwareqatest.com/qatweb1.html, etc., which tools, and resources are incorporated by reference.

In certain embodiments, end users and other third parties may provide feedback of any nature or type or as desired. For example, feedback may relate to the usefulness and/or quality and/or additional desired features and/or undesirable features of functions and/or bugs or errors contained within or relating to one or more modules. Such feedback may be provided by any applicable means, including manual reporting or, preferably, automated means. Methods to provide feedback include the use of Internet blogs, messages boards and/or by attaching notes to the module, system or framework or to any one or more related documents. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

The central PDT or an integrated or associated module may act as a billing engine to charge end users or other third parties for the use of plug-ins and may share or pay developers for the use of those plug-ins.

Examples of modules or plug-ins could include, but are not limited to, any one or more of a/an:
1. Lexicon Drafting Tool
2. Word Processor
3. Spreadsheet
4. Presentation Tool
5. Figure Drafting Tool
6. Image Processing Tool
7. Audio Processing Tool
8. Product demonstration or testing tool, e.g., a virtual environment
9. Prior Art Search Engine
10. Blog tool or system for submitting prior art, notes, documents, commentary, etc.
11. Voting system for office actions or for raking anything, e.g., notes
12. Notes Creation and Insertion Tool
13. Search Tool
14. License Exchange or Marketplace

In certain embodiments, access to or use of one or more plug-ins may be accomplish using hyperlinks. Hyperlinks may also be used to direct developers and/or end users or examiners to applications or plug-ins that permit user feedback, scoring, ranking and other information, such as adding notes, or logging errors, error messages, and/or requesting or suggesting new features or other design changes. Methods to create WebPages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which are hereby incorporated by reference.

As stated above, use of any Modules or Plug-ins can be subject to a fee. For example, end users may be billed on a per usage basis, or for a fixed one-time fee and/or based upon the amount of time used. Rates may vary based upon or determined by any applicable means, including, for example, any one or more discriminating attributes, including: a) the type of document or application, b) the size of the document, c) the age of the application, d) the results of one or more reviews by an end user or third party, e.g., a patent examiner, e) the class or subclass or other categorization of a document, e.g., a patent class and subclass, f) whether or not the end user has submitted or developed other modules for use within the system or framework and/or if such end user has provided review or other services, e.g., peer review of one or more modules, h) or any other factors such as need or social or economic class of the end user, or other status or discriminating factors known or established by the system, or any law, committee or other governing body or agency, e.g., the USPTO, or other laws passed by the United States of America or, if applicable any foreign country and/or any court of competent jurisdiction and/or any combination of the forgoing.

In some embodiments, prior to, and/or during and/or following use of one or more plug-ins, end users may or may be required to view one or more advertisements in exchange for free or reduced fees for using said one or more plug-ins. In such cases, the end user may be required to complete viewing of an advertisement, and/or click on a link to display or run such advertisements and/or such advertisements may automatically run at the desired time. In other embodiments, end users may optionally and/or may be required to respond to one or more survey questions. Such questions may be presented before during or after viewing of an advertisement. Exemplary systems and methods related to keyword-based advertising in a document database are described in U.S. patent application Ser. Nos. 11/668,586 “Targeted Advertising Based on Invention Disclosures,” filed Jan. 30, 2007; 11/668,596, “Keyword Advertising in Invention Disclosure Documents,” filed Jan. 30, 2007; ______ (Attorney docket No. 3303103) “Merchant Tool for Embedding Advertisement Hyperlinks to Words in a Database of Documents” filed Apr. 6, 2007; and ______ (Attorney docket No. 3303104) “Merchant Tool for Embedding Advertisement Hyperlinks to Words in a Database of Documents,” filed Apr. 6, 2007; each of which is hereby incorporated by reference.

In certain embodiments, the system, framework, module, plug-in or other application may track the usage of any part or all of the system, framework, plug-in or module for any desired purposes, including, but not limited to: billing end users, tracking system or module performance, determining popular vs. unpopular modules, which may or may not provide the similar functionality, in which case, unpopular modules may be deleted or barred from use, or to provide feedback to the owner, server hosts, developers or any other interested or otherwise authorized third party. For example, by tracking which features are used most often within a given module, one or more developers might use such information to help guide them in improving the existing module. Alternatively or additionally, developers may use such information to help improve the design of new modules, whether or not such modules provide similar or dissimilar functionality. In another example, by tracking which applications, features, modules or plug-ins receive the most favorable and/or unfavorable comments, feedback or notes, developers or any person or system responsible for monitoring performance or quality may be alerted to which features, functions, modules or plug-ins should be reviewed or more closely examined. For example, if module A receives ten times the number of unfavorable comments or notes as compared with other modules, the developer of module A may be notified to review or revise the application. Such notification may be provided via an alert. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

In another embodiment, individuals or corporations may be able to plug in their own search engine algorithms, GUIs, electronic wallet applications or any other plug-in or module, which may interface with or reside within or otherwise interact or communicate with the system, framework and/or patent database or other application or modules. Such individuals or corporations may charge others to use their interfaces, algorithms and/or modules.

In certain embodiments, the various inventions of the present disclosure may be practiced in the real or virtual world. For example, a video game may permit the inclusion of modules or plug-ins, which provide additional features or other improvements relating to the virtual environment, video game or improves game play. For example, a video game may include a virtual patent office. Exemplary methods and systems for providing protection of intellectual property in a virtual environment are disclosed, for example, in U.S. patent application Ser. Nos. 11/428,263, “Video Game Environment” filed Jun. 30, 2006; 11/620,563 “Copyright of Digital Works in a Virtual Environment,” filed Jan. 5, 2007; 11/689,977, “Digital Rights Management in a Virtual Environment,” filed Mar. 22, 2007; 11/671,373 “Video Game with Control of Quantities of Raw Materials” filed Feb. 5, 2007; 11/680,960 “System for the Creation and Registration of Ideas and Concepts in a Virtual Environment,” filed Mar. 1, 2007; each of which is incorporated herein by reference. Accordingly, the systems described herein may be applied to a virtual environment, world or video game(s). For example, use of modules or plug-ins, such as those disclosed herein may be delivered and/or used within the virtual world.

In the event an agreement between two or more parties may be desired or required to insert any module or plug-in and/or to make use of any such plug-in, a contract between such parties may be required. In such cases, methods to ensure that agreements are enforceable and that advertising fees are collected in such virtual environments are desirable. Exemplary methods for providing such contract enforcement and collection of fees are disclosed, for example, in U.S. patent application Ser. Nos. 11/279,991 “Securing Virtual Contracts with Credit,” filed Apr. 17, 2006; 11/624,662 “Securing Contracts in a Virtual World,” filed Jan. 18, 2007; 11/559,158 “Financing Options in a Virtual World” filed Nov. 13, 2006; 11/620,542 “Satisfaction of Financial Obligations in a Virtual Environment Via Virtual and Real World Currency,” filed Jan. 5, 2007; 11/421,025 “Financial Institutions and Instruments in a Virtual Environment,” filed May 30, 2006, and 11/380,489 “Multiple Purchase Options for Virtual Purchases,” filed Apr. 27, 2006; each of which are hereby incorporated herein by reference.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:
1. Plug in Certification Program
2. Billing Program
3. Marketplace Program
4. Use Plug in Program
5. File Patent Program

Exemplary database architectures include:

Plug In Database
1. Plug-in ID
2. Short Description
3. Long Description
4. Purpose
5. Developer ID 1-N
6. Features 1-N
7. Limitations 1-N
8. Authorized Users 1-N
9. Terms and Conditions for Use 1-N
   a. Fees for Use
   b. Fee sharing rules (if any), e.g., share with USPTO
   c. Limitations on Use
   d. License/Sublicense/Modification Rights/Limitations
10. Known Errors 1-N
11. Workarounds for known errors 1-N
12. Proposed Enhancements 1-N
13. Status/Project Plan/Timing for Enhancements 1-N
14. API Standard's ID 1-n
15. Date/Time Stamps
   a. Submitted On
   b. Expected Next Review Date
   c. Reviewed On-1-N
   d. Reviewed by Examiner ID 1-N
   e. Rejected/Accepted On
   f. Rejected Reasons ID 1-N
   g. Supervisor ID 1-N
   h. Notes 1-N
16. Plug-In (i.e., attachment, e.g., file and/or source and/or object code)
17. End User Or Examiner Review Notes ID 1-N
18. Notes 1-N

Notes Database
1. Note ID
   a. Hyperlinks 1-N
   b. Note Description Short
   c. Note Description Long
   d. Note Group ID
   e. Note Class ID
   f. Note Subclass ID
   g. Note and/or Note Attachments 1-N
   1. Submitted By ID
   2. Submission Date/Time
2. Notes 1-N

Rejection Reasons Database
1. ID
2. Description
3. Long Description
4. Possible or Recommendation to correct notes ID 1-N
5. Notes 1-N

Acceptance Reasons Database
1. ID
2. Description
3. Long Description
4. Notes ID 1-N

Examiner Database
1. ID
2. Name
3. Security Profile
4. Address
5. Security Profile
6. Qualifications 1-N
7. Skills 1-N
8. Previous Plug-Ins Reviewed IDs 1-N
9. Notes ID 1-N

User Database
1. User ID
2. Name
3. Security Profile
4. Account Type
5. Description
6. Security Profile
7. Terms and Conditions ID
8. Qualifications ID 1-N
9. Skills ID 1-N
10. Notes ID 1-N
11. Plug-in Usage IDs 1-N
12. Previous Plug-In Review IDs 1-N
13. Field of Use 1-N
14. Financial Information
   a. Billing Method ID
   b. Credit Card Information
      1. Preferred Card Number
      2. Preferred Card Holder
      3. Preferred Card Type
      4. Name
      5. Expiration Date
      6. Security Code
   c. Additional Cards 1-N
      1. Card Number
      2. Card Holder (e.g., Bank Name)
      3. Card Type (e.g., Visa)
      4. Name
      5. Expiration Date
      6. Security Code
15. User Mailing/Billing Address
16. Notes 1-N

Qualifications Database
1. Qualification ID
2. Description
3. Qualification Type
4. Years Experience
5. Fields of Use Applicable 1-N
6. Notes ID 1-N

Skills Database
1. Skill ID
2. Description
3. Type
4. Years Experience
5. Fields of Use Applicable 1-N
6. Notes ID 1-N

Billing Terms and Conditions Database
1. Billing Method ID
2. Billing Type
3. Description
4. Billing Frequency
5. Due by #days
6. Late by #days
7. Interest Rate Fixed
8. Interest Rate Variable
9. Interest Accrues after days
10. Notes 1-N

Accounts Receivable Database
1. User ID
   Total Amount Owed
2. Transaction Detail Records 1-N
   a. Date of Transaction
   b. Type
   c. Document ID
   d. Word ID
   e. Hyperlinks 1-N
   f. Amount
3. Notes 1-N

Transaction Database
1. Transaction ID
2. Description
3. Date/Time
4. Type
5. User ID
6. Plug-in ID 1-N
7. Billing T&C's 1-N
8. Billing Method ID
9. Transaction Amount
10. Results 1-N
   a. Plug-in Used
      1. Start/End Date/Time
      2. Total Duration
   b. Note Added, Changed, Deleted, and/or Accessed
   c. Hyperlink Clicked
   d. Sub-Hyperlinks Clicked 1-N
      1. Advertisement/Note and/or Webpage) Displayed 1-N
      2. Click Through y/n
      3. Duration of View
      4. Conversion Y/N
11. Notes 1-N

Developer Database
a. Developer ID
b. Name
c. Address
d. Qualification IDs 1-N
e. Skill IDs 1-N
f. Plug-Ins Submitted ID-1-N
g. Notes ID 1-N

Change Tracking Database
a. Change Tracking ID
b. Plug-In ID
c. Change Type (e.g., Add, change, delete)
d. Purpose (new feature, error correction, etc.)
e. Change Description
f. Date/Time
g. Developer ID
h. Before Image
i. After Image
j Quality Ranking or Score
k. Notes ID 1-N

Alert Event Rules Database
a. Alert Event Rule ID
b. Alert Event Description
c. Alert Event Rules 1-N
   1. Event Condition
   2. Alert Recipient ID 1-N
      a. Alert Method 1-N
   3. Alert Database ID 1-N
d. Notes 1-N

Alert Database
a. Alert Database ID
b. Alert Contents, one or more of:
   1. Text
   2. Variable Data
   3. Executable
c. Notes 1-N

Alert Methods Database
a. Alert Method ID
b. Method Type
c. Delivery Method (cell phone, pager, e-mail, PDA, database, executable, etc.)
d. Notes 1-N

Alert Recipient Database
a. Alert Recipient ID (e.g., end user ID)
b. Description
c. Alert Method Preferences ID 1-N
d. Notes 1-N

Accounts Receivable Database
a. Advertiser/Note Owner ID
   Total Amount Owed
b. Transaction Detail Records 1-N
   1. Date of Transaction
   2. Type
   3. Advertisement ID
   4. Word ID
   5. Hyperlinks 1-N
c. Amount per impression or click through
   d. Notes 1-N

Plug in Type Database
1. Plug-in Type ID
2. Description
3. APIs allowed 1-N
4. APIs prohibited 1-N
5. Languages allowed 1-N
6. Languages permitted 1-N
7. Notes 1-N

Marketplace Database

Document Database
1. Document ID
   a. Document Description
   b. Document Owner ID
   c. Hyperlinks (e.g., document locations) 1-N
   d. Class 1-N
   e. Subclass 1-N
   f. Type 1-N
   g. Subtype 1-N
   h. Date/Time Stamps
      1. Submitted/Found/Indexed On
      2. Submitted/Found/Indexed By ID or Hyperlink
      3. Revised On 1-N
      4. Revised By 1-N
      5. Before Image 1-N
      6. After Image 1-N
   i. Notes 1-N

Hyperlink Database
1. Hyperlink ID
2. Hyperlink
3. Description
4. Owner ID
5. Advertiser ID
6. Notes 1-N

It will be appreciated that the various software and hardware components described above will be configured to perform a variety of functions and methods. Listed below are some exemplary methods that might be performed by the systems as described herein:

Creating and Submitting the Plug-In
1. A developer creates a plug-in via any applicable means, for example, using an software development tool or editor
2. Developer submits plug-in to review application/group
3. Review determines usefulness and quality of plug-in if useful and of acceptable apparent quality, plug-in moves to formal testing phase.

Testing or Certifying the Plug-In
1. Review application or group tests plug-in via any applicable means, for example:
   a. Initial testing is outside production system
   b. Secondary testing is inside production system but on limited basis with few users
   c. If the plug-in passes these tests, it is inserted or otherwise linked via the API
   d. Otherwise the system creates error/bug lists
   e. Either case, the system notifies the affected party, via alerts

Using the Plug-In
1. End users may request to see a list of available plug-ins and/or may select them from within various applications
2. End users may make use of the Plug-in as necessary or desired
3. System tracks usage, frequency, duration, errors

Providing Feedback
1. End users may provide feedback (formal or informal)
2. End users may provide usability, relevancy or other rankings and/or scores

Billing for the Use of the Plug-In
1. System determines end users access, use and duration
2. System Determines Fees Due
3. System determines credits for developer and/or end user contributions and deducts such credits from fees due
4. System sends invoices for the balance due to end users and notifications to plug-in owners

Fix Bugs for Certification
1. If testing fails, developer receives notice and list of errors and/or desired features
2. Developer either withdraws the plug-in from further consideration or corrects errors and/or adds requested features and resubmits for review

File Document Program
1. Receive a request to file a document using a file document plug in
2. Output plug in with document filing forms
3. Receive Document
4. File Document
5. Bill Document Filer
6. Pay plug in provider for use of plug in to file document

Or Event Driven Model

Initial Database Loading
1. Create/Load Initial Database(s)
2. Update Database(s)

Primary Plug-In System
1. Load Database(s)
2. Display primary GUI
3. Receive activity indication/request from end user
4. Determine if one or more subroutines should be executed
5. Execute one or more of the following subroutines as applicable/necessary/desired
6. Update database(s)

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Opt In/Sign Up Application
1. Load Databases
2. Receiving Indication of new user sign up
3. Record any and all or available information regarding end users and/or one or more submitted or proposed plug-ins and/or modifications thereto
4. Update Databases

Plug in Submission/Certification Program
1. Load Database(s)
2. Receive indication of end user or application submission of new or modified plug-in
3. Determine plug-in type, category and purpose and end user's qualifications
4. Determine if plug-in type, category or purpose requires review, testing, approval, based upon type, purpose and/or end user qualifications/history
5. If required, submit for review, testing, approval
6. Receive indication that plug-in qualifies and/or is tested and/or approved
7. If approved, insert plug-in, or activate API and/or include hyperlink where and as indicted
8. Update Databases

Plug-In Testing Program
1. Load Database(s)
2. Receive plug-in for testing
3. Test plug-in as required using any one or more of:
   a. Manual testing/quality assurance reviews
   b. Automated Testing tools
   c. Virtual Reality Testing/Prototyping
   d. Peer Review
4. Determine errors, shortcomings, ease of use, usefulness ratings
5. Notify end user of any/all issues, e.g., via an alert
6. Await revised plug-in and repeat process until plug-in passes all or generally all, or all critical testing phases
7. Approve Plug-in
8. Update database(s)

Billing Program
1. Load Database(s)
2. Receive indication that billing activity has occurred
3. Determine affected parties, e.g., payer and payee
4. Determine billing rules, terms and conditions
5. Determine Billing Amounts Due
6. Create Invoice and A/P or A/R notices/entries
7. Send Invoices and notices
8. Update Databases
9. Await Payment
10. Receive Payment Indication
11. Apply Payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Use Plug in Program
1. Load Database(s)
2. Execute Security Application
3. Run Host or Primary Application (e.g., Patent Drafting Tool)
4. Permit use of one or more plug-ins—activation via, e.g., Hyperlinks or use of features via Host application's API or GUI
5. Track Usage Data
6. Gather feedback/relevancy information—e.g., execute relevancy program
7. Update Database(s)

Plug-in Feedback/Relevance Program
1. Load Database(s)
2. Receive Feedback and/or Relevancy Input from End Users
3. Or use automated application to determine relevancy, e.g., via GA
4. Associate Feedback and/or Relevancy with Notes
5. Provide feedback and/or relevancy (detail or summary) to end user's
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a web-based patent application drafting tool (PDT) to a plurality of end users;
receiving a software module from a third party software developer, wherein the software module is intended to be used with the PDT;
determining if the software module meets initial quality criteria;
allowing a subset of the plurality of end users to use the software module;
receiving feedback from the subset of end users regarding the software module;
providing the feedback to the software developers;
receiving an updated version of the software module; and
providing the software module to the plurality of end users.

2. The method of claim 1 further comprising:
receiving a fee from the end users for using the PDT; and
providing a fee discount to the software developer.

3. The method of claim 1 further comprising monitoring usage of the software module by the plurality of end users.

4. The method of claim 3 further comprising setting a fee schedule for the software module based on the monitored usage.

5. The method of claim 2 further comprising monitoring usage of the software module by the plurality of end users.

6. The method of claim 5 further comprising determining the amount of the fee discount based on the monitored usage.

7. A method comprising:
submitting a software module to an entity that provides a patent application drafting tool (PDT) to a plurality of end users for a fee, wherein the software module is intended to be used in association with the PDT;
receiving feedback from the entity regarding the software module;
receiving a fee reduction from the entity for use of the PDT if the entity agrees to provide the software module to the plurality of end users.
